(19) United States
(12) Patent Application Publication
(10) Pub. No.: US 2026/0229821 A1
(43) Pub. Date: Aug. 6, 2026

(54) RECEPTACLE CONNECTOR, PLUG CONNECTOR AND ELECTRICAL CONNECTION DEVICE

(71) Applicant: Molex, LLC, Lisle, IL (US)

(72) Inventors: Eng Kan Soh, Singapore (SG); Chen Yew Lim, Singapore (SG)

(21) Appl. No.: 19/455,885

(22) Filed: Jan. 22, 2026

(30) Foreign Application Priority Data
Jan. 24, 2025 (CN) 202510119123.5

(51) Int. Cl. H01R 13/631; H01R 12/71; H01R 12/79; H01R 13/05; H01R 13/424; H01R 13/506; H01R 13/627; H01R 13/6595

(52) U.S. Cl. CPC H01R 13/631; H01R 12/716; H01R 12/79; H01R 13/055; H01R 13/424; H01R 13/506; H01R 13/6275; H01R 13/6595

(57) ABSTRACT

A receptacle connector, a plug connector and an electrical connection device are provided. The receptacle connector includes a metal shell, an insulative base and a receptacle terminal assembly. The insulative base is provided in the metal shell, is in form of annulus and includes an insertion opening. The receptacle terminal assembly is provided in the insulative base and includes two terminal bases, a protective base which is provided between the two terminal bases, and two receptacle terminal groups which are respectively provided to the two terminal bases. The protective base and the two receptacle terminal groups are spaced apart from each other. Each receptacle terminal group extends toward the insertion opening but does not protrude from the protective base. The receptacle connector has a technical effect that the two receptacle terminal groups may be avoided being damaged due to collision.

### TECHNICAL FIELD

The present disclosure relates to a PCIe computer bus, and particularly relates to a receptacle connector, a plug connector and an electrical connection device.

### BACKGROUND

Chinese patent document CN117913566A discloses an electrical connection device, including a receptacle connector and a plug connector which separably mates with the receptacle connector. The receptacle connector includes a receptacle terminal assembly which is connected with a circuit board. The plug connector includes a plug terminal assembly which separably abuts against the receptacle terminal assembly.

A deficiency of the electrical connection device in the prior art lies in that, in a process that the plug connector mates with the receptacle connector, that the plug connector collides the receptacle terminal assembly or the receptacle connector collides the plug terminal assembly may occur, which results in deformation of terminal(s) of the receptacle assembly or deformation of terminal(s) of the plug terminal assembly, and in turn results in a problem that contact between the terminal(s) of the plug terminal assembly and the terminal(s) of the receptacle assembly is poor or the terminal(s) of the plug terminal assembly and the terminal(s) of the receptacle assembly cannot contact each other to make the electrical connection device fail, it needs to be further improved.

### SUMMARY

An object of a receptacle connector of the present disclosure is to improve at least one deficiency in the prior art.

A receptacle connector of the present disclosure comprises a metal shell, an insulative base and a receptacle terminal assembly. The insulative base is provided in the metal shell, is in form of annulus and comprises an insertion opening. The receptacle terminal assembly is provided in the insulative base and comprises two terminal bases, a protective base which is provided between the two terminal bases, and two receptacle terminal groups which are respectively provided to the two terminal bases. The protective base and the two receptacle terminal groups are spaced apart from each other. Each receptacle terminal group extends toward the insertion opening but does not protrude from the protective base.

A technical effect of the receptacle connector of the present disclosure lies in that: because the protective base may prevent the two receptacle terminal groups from being collided, the receptacle connector has a technical effect that the two receptacle terminal groups may be avoided being damaged.

An object of the present disclosure is to improve at least one deficiency in the prior art.

A plug connector of the present disclosure comprises a plug housing unit and two plug terminal groups. The plug housing unit comprises a housing peripheral wall which defines an inserting space, and two first protecting walls which connect the housing peripheral wall. The inserting space comprises an inserting opening. The two first protecting walls are positioned beside the inserting opening and extend toward each other to cooperate with each other and define an insert opening. Each plug terminal group comprises a tip. Each tip is sheltered by the respective first protecting wall so that the tip is not exposed in the insert opening.

A technical effect of the present disclosure lies in that: each first protecting wall may prevent the tip of the respective plug terminal group from being collided, the plug connector has a technical effect that the two plug terminal groups may be avoided being damaged.

An object of the present disclosure is to improve at least one deficiency in the prior art.

An electrical connection device of the present disclosure comprises the aforementioned receptacle connector and the aforementioned plug connector. The plug connector mates with the receptacle connector.

A technical effect of the present disclosure lies in that: the electrical connection device comprises the aforementioned receptacle connector and the aforementioned plug connector, the two receptacle terminal groups may be avoided being collided by the plug connector and the two plug terminal groups may be avoided being collided by the receptacle connector when the plug connector inserts into the receptacle connector, the electrical connection device has a technical effect that the two receptacle terminal groups and the two plug terminal groups may be avoided being damaged.

### BRIEF DESCRIPTION OF THE DRAWINGS

Other features and technical effects of the present disclosure will be apparent from embodiments with reference to the drawings, in which:

FIG. 1 is a perspective view illustrating a state that the receptacle connector and the plug connector mate with each other in a first embodiment of a receptacle connector, a plug connector and an electrical connection device of the present disclosure;

FIG. 2 is a cross-sectional view illustrating a state that the receptacle connector and the plug connector mate with each other;

FIG. 3 is a perspective exploded view incompletely exploded and illustrating that the plug connector is separated from the receptacle connector;

FIG. 4 is a perspective exploded view incompletely exploded and illustrating an assembling relationship among a metal shell, an insulative base and a receptacle terminal assembly of the receptacle connector;

FIG. 5 is a cross-sectional view illustrating the receptacle connector;

FIG. 6 is a perspective exploded view illustrating an assembling relationship between two terminal bases and a protective base of the receptacle terminal assembly and illustrating structures of two receptacle terminal groups at the same time;

FIG. 7 is a cross-sectional view illustrating an assembling relationship between the two terminal bases and the protective base;

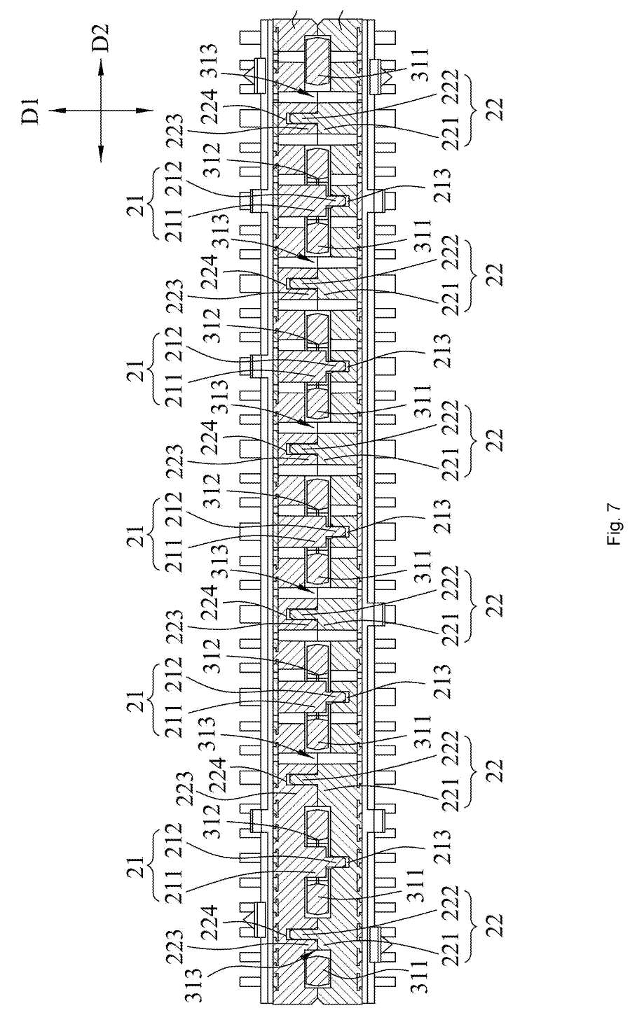

FIG. 8 is a perspective exploded view incompletely exploded and illustrating the plug connector;

FIG. 9 is a cross-sectional view illustrating the plug connector;

FIG. 10 is a bottom view illustrating the plug connector;

FIG. 11 is a cross-sectional view illustrating an assembling process of the receptacle connector and the plug connector; and

FIG. 12 is a cross-sectional view illustrating the receptacle connector of a second embodiment of the receptacle connector, the plug connector and the electrical connection device of the present disclosure.

### REFERENCE NUMERALS ARE PRESENTED AS FOLLOWS

1 electrical connection device

11 receptacle connector

12 plug connector

131 metal shell

131a inserting leg

132 insulative base

14 receptacle terminal assembly

15 plug housing unit

16 plug terminal group

2 terminal base

21 first engaging portion

211 first protruding block

212 first inserting block

213 first inserting hole

22 second engaging portion

221 second protruding block

222 second inserting block

223 socketing block

224 second inserting hole

3 protective base

31 leg portion

311 leg

312 engaging hole

313 interval

32 base portion

321 oblique surface

322 bottom surface

33 flange portion

331 side surface

332 curved surface

332a curved surface edge

333 end oblique surface

5 receptacle terminal group

5a signal terminal

5bground terminal

51 body portion

52 contacting portion

521 tip

53 soldering portion

61 bottom housing

62 cover housing

63 housing peripheral wall

631 long wall portion

632 short wall portion

64 first protecting wall

641 first wall surface

642 second wall surface

643 wall edge

65 second protecting wall

71 body portion

72 contacting portion

721 tip

9 circuit board

A1 angle between wall surfaces

D1 front-rear direction

D2 left-right direction

D3 third direction

O1 insertion opening

O2 inserting opening

O3 insert opening

S1 inserting space

### DETAILED DESCRIPTION

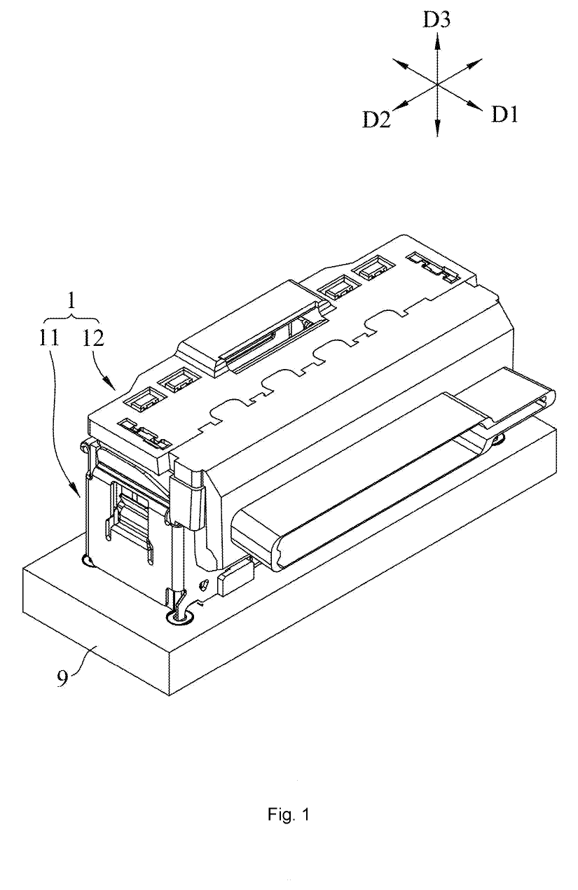

Referring to FIG. 1 to FIG. 3, in a first embodiment of a receptacle connector, a plug connector and an electrical connection device of the present disclosure, an electrical connection device 1 includes a receptacle connector 11 and a plug connector 12 which separably mate with each other.

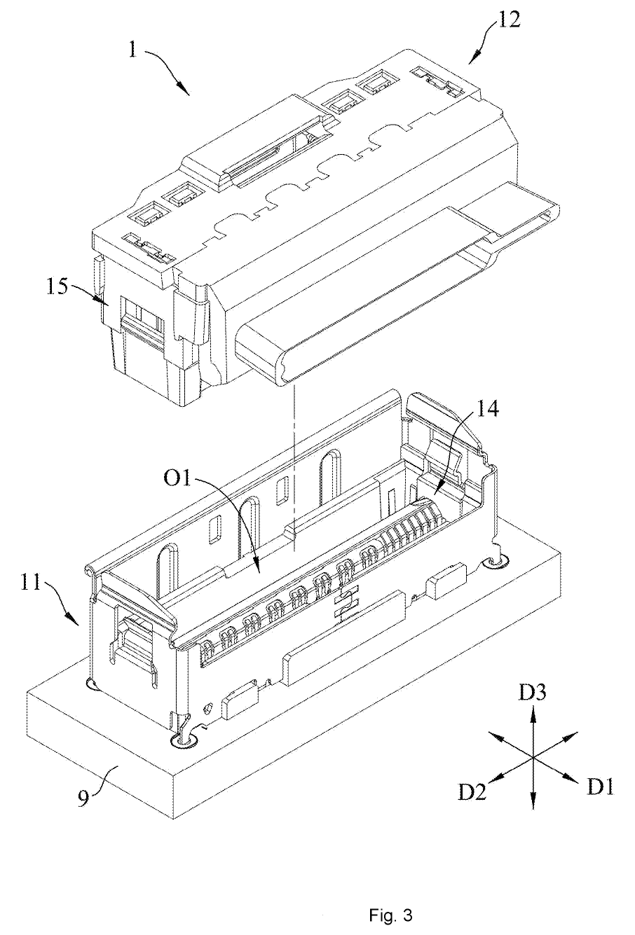

Referring to FIG. 3 to FIG. 5, the receptacle connector 11 is adapted to be mounted on a circuit board 9, and includes a metal shell 131, an insulative base 132 surrounded by the metal shell 131, and a receptacle terminal assembly 14 provided in the insulative base 132. Wherein, the receptacle connector 11 is inserted into and fixed on the circuit board 9 via the metal shell 131.

The metal shell 131 is in form of rectangular shell, and includes a plurality of inserting legs 131a which are respectively positioned to four corners of the metal shell 131. The metal shell 131 is inserted into on the circuit board 9 via the plurality of inserting legs 131a.

The insulative base 132 is surrounded by the metal shell 131 and is snapped in the metal shell 131. The insulative base 132 is in form of rectangular frame and may receive the receptacle terminal assembly 14. The insulative base 132 includes an insertion opening O1 which is away from the circuit board 9 and is opened upwardly.

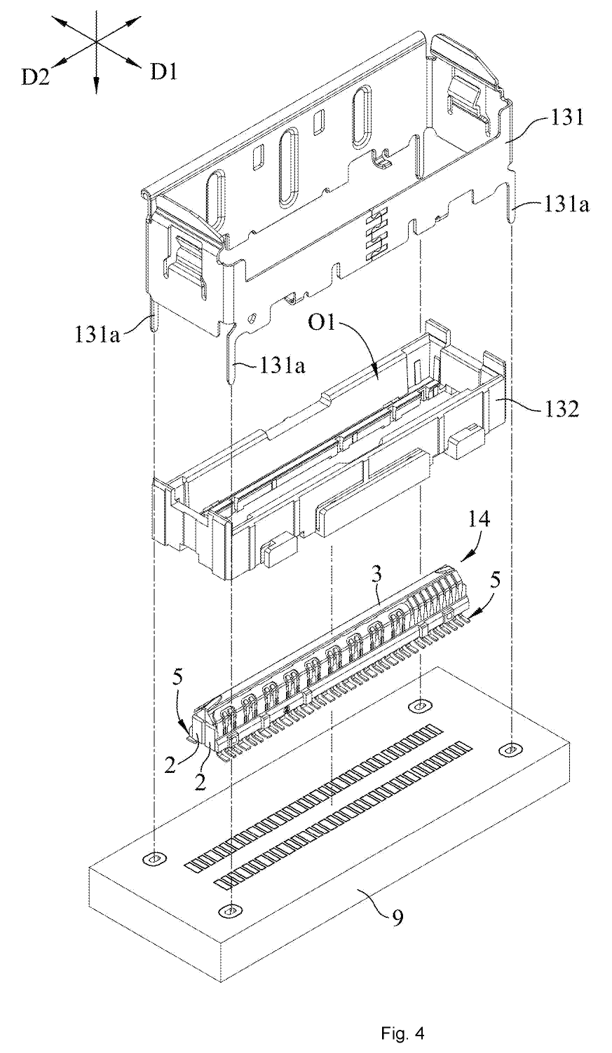

Referring to FIG. 4 to FIG. 6, the receptacle terminal assembly 14 includes two terminal bases 2 which mate with and assemble with each other front and rear along a front-rear direction D1 and extend left and right along a left-right direction D2, a protective base 3 which is provided between the two terminal bases 2, and two receptacle terminal groups 5 which are respectively provided to the two terminal bases 2.

A thickness direction of each terminal base 2 is the same as the front-rear direction D1. The two terminal bases 2 sandwich the protective base 3 respectively from a front side and a rear side of the protective base 3 in the front-rear direction D1.

The two terminal bases 2 include a plurality of first engaging portions 21 and a plurality of second engaging portions 22. The plurality of first engaging portions 21 and the plurality of second engaging portions 22 are staggered with each other in the left-right direction D2.

Each first engaging portion 21 includes a first protruding block 211 and a first inserting block 212 which are positioned on one terminal base 2, and a first inserting hole 213 which is formed on a body of the other terminal base 2. A width of each first protruding block 211 is larger than a width of the respective first inserting block 212. Each first inserting hole 213 allows the respective first inserting block 212 to insert therein.

Each second engaging portion 22 includes a second protruding block 221 and a second inserting block 222 which are positioned to one terminal base 2, a socketing block 223 which is positioned on the other terminal base 2, and a second inserting hole 224 which is formed on the socketing block 223. A width of each second protruding block 221 is larger than a width of the respective second inserting block 222. Each socketing block 223 is capable of engaging with the respective second protruding block 221. Each second inserting hole 224 allows the respective second inserting block 222 to insert therein.

In other implementing manners of the present disclosure, each first engaging portion 21 and each second engaging portion 22 may be interchanged in construction. Specifically, each first engaging portion 21 may employ the second protruding block 221, the second inserting block 222, the socketing block 223 and the second inserting hole 224 in design, and each second engaging portion 22 may employ the first protruding block 211, the first inserting block 212 and the first inserting hole 213 in design.

In an embodiment, the first protruding block 211 of the first engaging portion 21 may be omitted, and the second protruding block 221 and the socketing block 223 of the second engaging portion 22 may be omitted.

The protective base 3 is made from an insulative material, and the protective base 3 is positioned between the two receptacle terminal groups 5 and is spaced apart from the two receptacle terminal groups 5 front and rear. The protective base 3 includes a leg portion 31 which is provided between the two terminal bases 2, a base portion 32 which is integrally connected to a top end of the leg portion 31, and a flange portion 33 which integrally protrudes upwardly from the base portion 32 along a third direction D3.

The leg portion 31 includes a plurality of legs 311 which are spaced apart from each other. The plurality of legs 311 define multiple engaging holes 312 and multiple intervals 313. The multiple legs 311 of the plurality of legs 311 each are in form of square annulus so that the multiple legs 311 of the plurality of legs 311 respectively define the multiple engaging holes 312 which each are in form of square hole. The two legs 311 of the plurality of legs 311 which are respectively positioned to a left side and a right side of the plurality of legs 311 each are in form of in form of solid block.

Each engaging hole 312 allows the first protruding block 211 and the first inserting block 212 of the respective first engaging portion 21 to insert therein. Each interval 313 allows the second protruding block 221, the second inserting block 222 and the socketing block 223 of the respective second engaging portion 22 to insert therein.

In other implementing manners of the present disclosure, the plurality of second engaging portions 22 may be omitted, because as long as the plurality of first engaging portions 21 respectively insert into the multiple engaging holes 312, it may avoid the protective base 3 being detached from the two terminal bases 2. Further, in other implementing manners of the present disclosure, in addition to that the plurality of second engaging portions 22 may be omitted, the multiple intervals 313 may be further omitted. For example, the plurality of legs 311 are integrally connected with each other. The leg portion 31 also may be regarded as a single long piece which extends left and right and is formed with the multiple engaging holes 312.

Although the present disclosure may omit the plurality of second engaging portions 22 and/or the multiple intervals 313 in implementation as described previously, a benefit of the present embodiment which at the same time includes the plurality of second engaging portions 22 respectively insert into the multiple intervals 313 lies in that: the plurality of second engaging portions 22 may cooperatively support the protective base 3. Specifically, when the plug connector 12 is inserted into or pulled out from the receptacle connector 11, in addition to that the plurality of second engaging portions 22 may disperse stress subjected by the base portion 32, the plurality of second engaging portions 22 may further cooperate with the plurality of first engaging portions 21 to limit the plurality of legs 311 in position, which avoids the leg portion 31 and the base portion 32 being deformed.

The base portion 32 is positioned between the two receptacle terminal groups 5, and abuts against top ends of the two terminal bases 2. The base portion 32 includes two oblique surfaces 321 which extend toward each other and toward the insertion opening O1 of the insulative base 132, and two bottom surfaces 322 which are respectively positioned below the two oblique surfaces 321. The two bottom surfaces 322 respectively abut against the top ends of the two terminal bases 2.

The flange portion 33 extend from a top end of the base portion 32 toward the insertion opening O1 of the insulative base 132 and protrude from the two receptacle terminal groups 5. The flange portion 33 includes two side surfaces 331 which are spaced apart from each other front and rear along the front-rear direction D1 and extend along the third direction D3, a curved surface 332 which is connected to top ends of the two side surface 331, and two end oblique surfaces 333 which are respectively positioned to a left end and a right end of the curved surface 332 in the left-right direction D2.

The curved surface 332 curves toward the insertion opening O1 of the insulative base 132 and protrude from the two receptacle terminal groups 5 to be higher than the two receptacle terminal groups 5. The curved surface 332 includes a curved surface edge 332a which is positioned to a top end of the curved surface 332 in the third direction D3. The third direction D3 is the same as an up-down direction. The two end oblique surfaces 333 extend away from each other left and right toward the base portion 32.

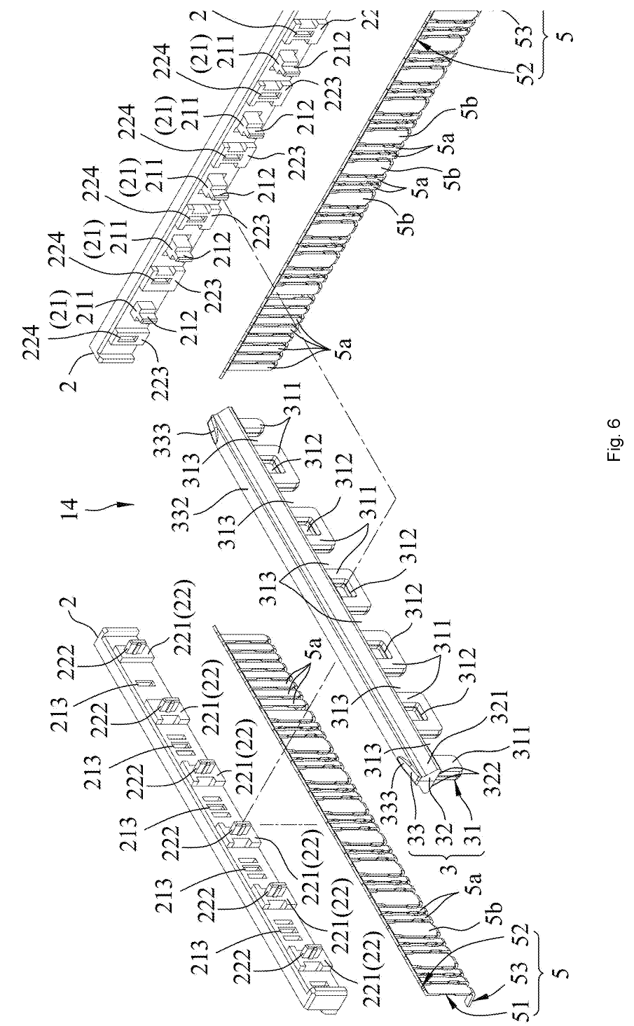

Each receptacle terminal group 5 is embedded in the respective terminal base 2 by insert molding, so separation of the two receptacle terminal groups 5 in FIG. 6 is only for illustrating structures of the two receptacle terminal groups 5, and is not representative of a practical assembling relationship. Each receptacle terminal group 5 includes multiple signal terminals 5a and multiple ground terminals 5b.

The signal terminals 5a of the multiple signal terminals 5a are used to transmit signals in higher speed, the other signal terminals 5a of the multiple signal terminals 5a are used to transmit signals in lower speed. The signal terminals 5a used to transmit signals in higher speed take every two signal terminals 5a as one group with the two ground terminals 5b respectively provided at a left side and a right side of the one group so as to avoid crosstalk between the signal terminals 5a in different groups which transmit signals in higher speed. The signal terminals 5a used to transmit signals in lower speed may be continuously provided side by side.

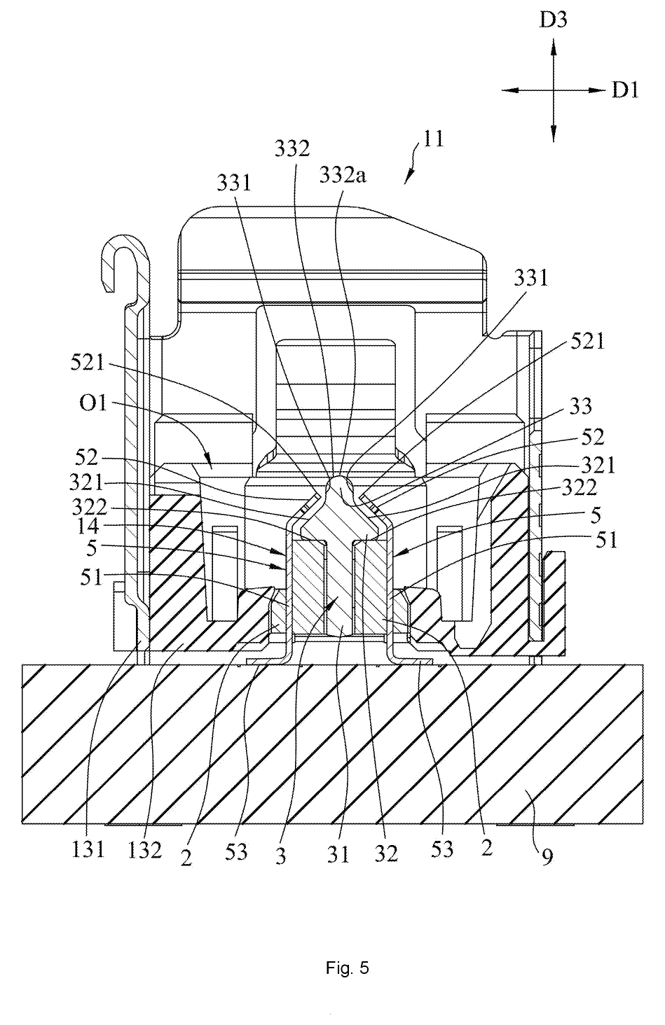

The multiple signal terminals 5a and the multiple ground terminals 5b of each receptacle terminal group 5 cooperate with each other to constitute a body portion 51 which extends up and down along the third direction D3, a contacting portion 52 (see FIG. 5) which is positioned above the body portion 51 and is toward the insertion opening O1, and a soldering portion 53 which is positioned below the body portion 51 and is adapted to electrically connect the circuit board 9.

The contacting portions 52 of the two receptacle terminal groups 5 extend upwardly toward the insertion opening O1 and toward each other. Each contacting portion 52 is parallel to the respective oblique surface 321 of the protective base 3, and is spaced apart from the oblique surface 321. Each contacting portion 52 includes a tip 521 which is positioned to a top end of the contacting portion 52 in the third direction D3. Each tip 521 is lower than the curved surface edge 332a of the protective base 3. Or in other words, each receptacle terminal group 5 extends toward the insertion opening O1 but does not protrude from the protective base 3.

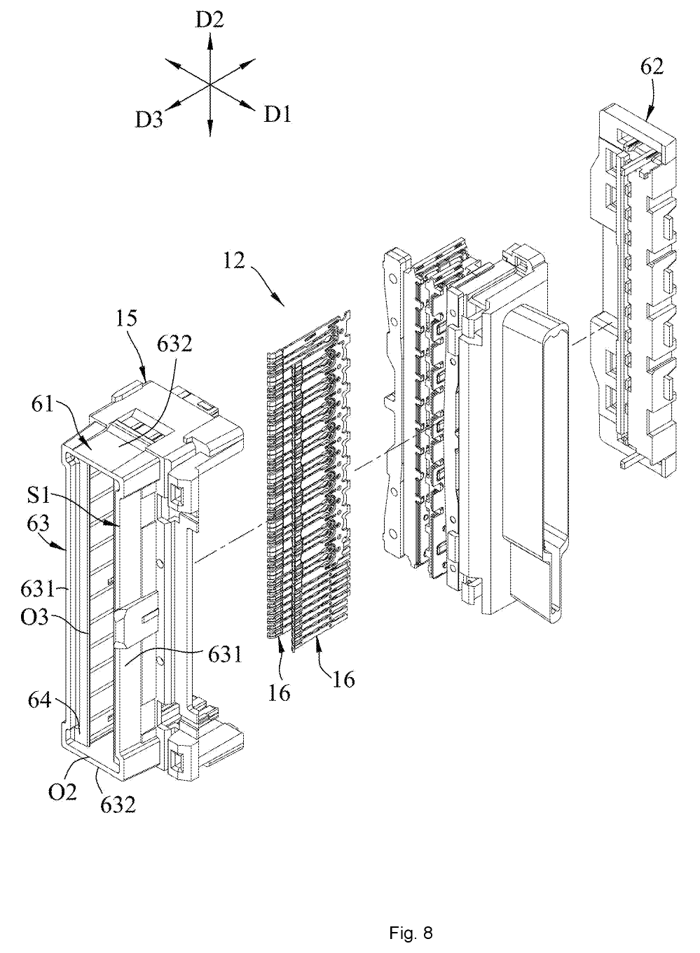

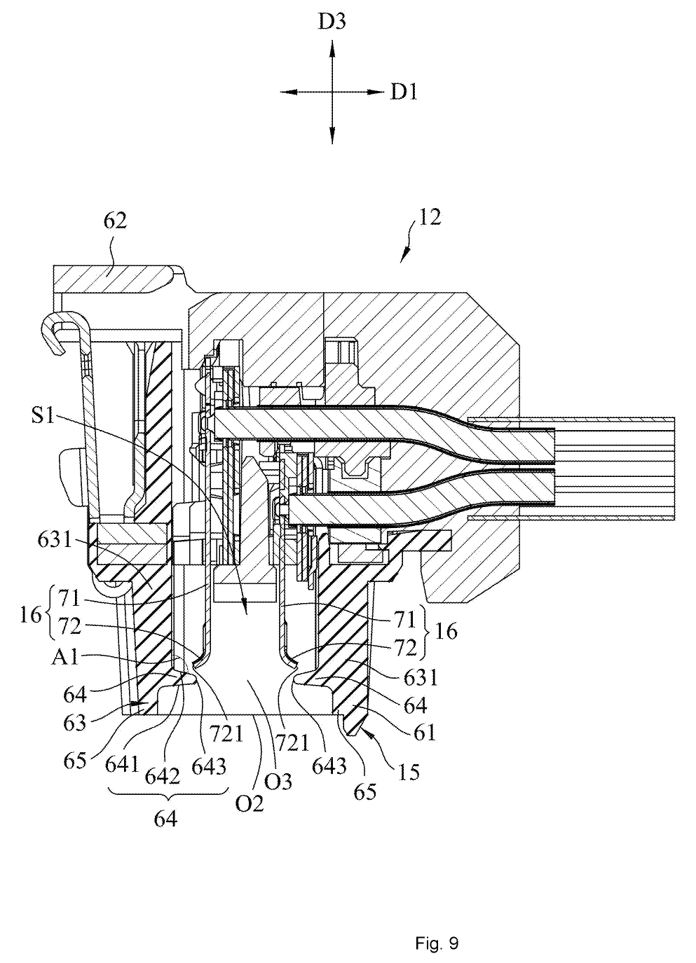

Referring to FIG. 3, FIG. 8 and FIG. 9, the plug connector 12 includes a plug housing unit 15 and two plug terminal groups 16 provided in the plug housing unit 15.

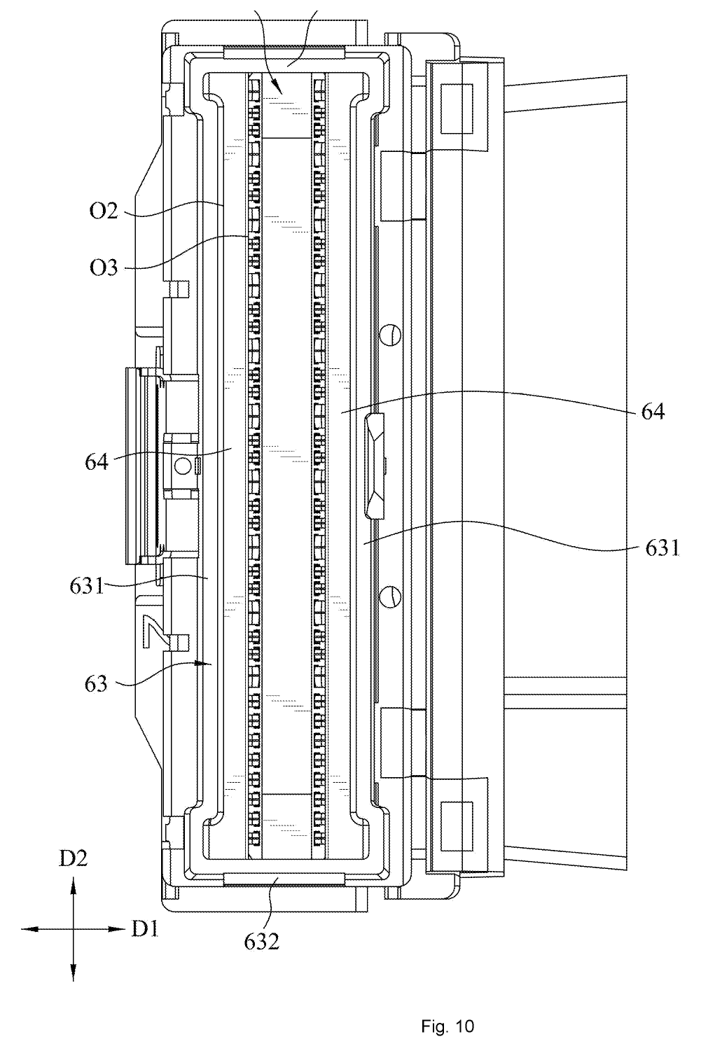

Referring to FIG. 8 to FIG. 10, the plug housing unit 15 includes a bottom housing 61 and a cover housing 62 covering the bottom housing 61.

The bottom housing 61 includes a housing peripheral wall 63 and two first protecting walls 64 connecting the housing peripheral wall 63.

The housing peripheral wall 63 includes two long wall portions 631 and two short wall portions 632. The two long wall portions 631 are spaced apart from each other along the front-rear direction D1. Each long wall portion 631 extends lengthwise along the left-right direction D2. The two short wall portions 632 are spaced apart from each other along the left-right direction D2. Each short wall portion 632 extends along the front-rear direction D1 and is connected between the two long wall portions 631. The two long wall portions 631 and the two short wall portions 632 cooperate with each other to define an inserting space S1. The inserting space S1 includes an inserting opening O2 which is toward the receptacle connector 11.

Each first protecting wall 64 is adjacent to the inserting opening O2. Specifically, each first protecting wall 64 is positioned in the inserting space S1, and is close to an outer edge of the long wall portion 631and outer edges of the two short wall portions 632 in the third direction D3. Each first protecting wall 64 extends lengthwise along the left-right direction D2, and is connected between the two short wall portions 632. The two first protecting walls 64 extend respectively from the two long wall portions 631 toward each other to cooperate with each other and define an insert opening O3. The insert opening O3 is spaced apart from the inserting opening O2 in the third direction D3.

Besides the two first protecting walls 64, in the present embodiment, a part of the housing peripheral wall 63 which is positioned between each first protecting wall 64 and the inserting opening O2 forms a second protecting wall 65, the two second protecting walls 65 are respectively positioned to the two long wall portions 631.

Each first protecting wall 64 includes a first wall surface 641 which is toward the inserting opening O2, a second wall surface 642 which is away from the inserting opening O2, and a wall edge 643 which is connected between the first wall surface 641 and the second wall surface 642 and is toward the other first protecting wall 64.

Each first wall surface 641 and the respective second wall surface 642 extend away from the long wall portion 631 of the housing peripheral wall 63 and toward each other.

An angle A1 between each second wall surface 642 and a wall surface of the housing peripheral wall 63 is an obtuse angle.

The two plug terminal groups 16 are arranged front and rear along the front-rear direction D1. A width direction of each plug terminal group 16 is the same as the left-right direction D2, and includes a body portion 71 which extends along the third direction D3, and a contacting portion 72 which extends from the body portion 71 toward the respective first protecting wall 64.

Each contacting portion 72 includes a tip 721 which is close to the respective first protecting wall 64. Each tip 721 is sheltered by the respective first protecting wall 64 so that the tip 721 is not exposed in the insert opening O3.

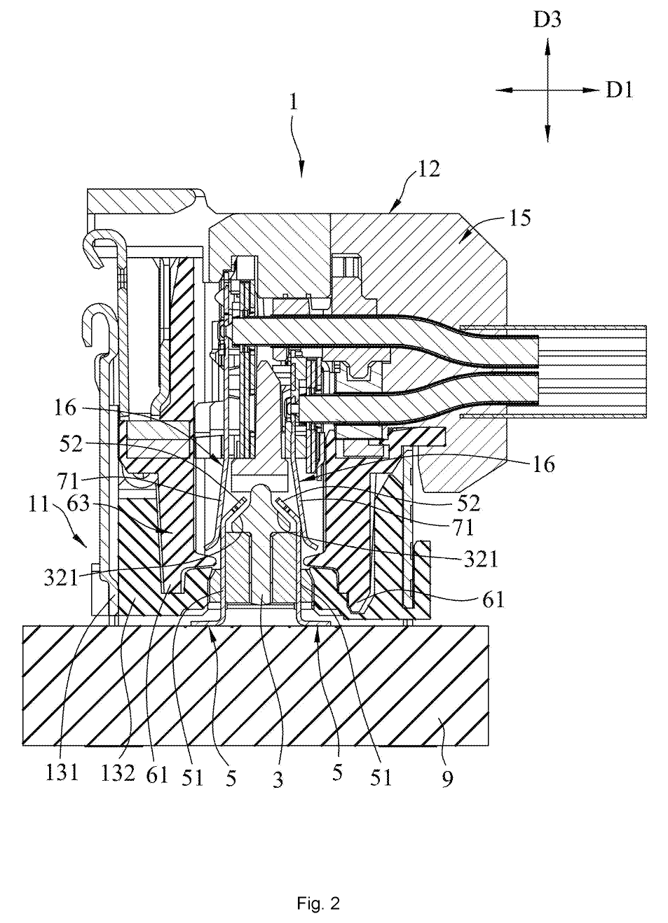

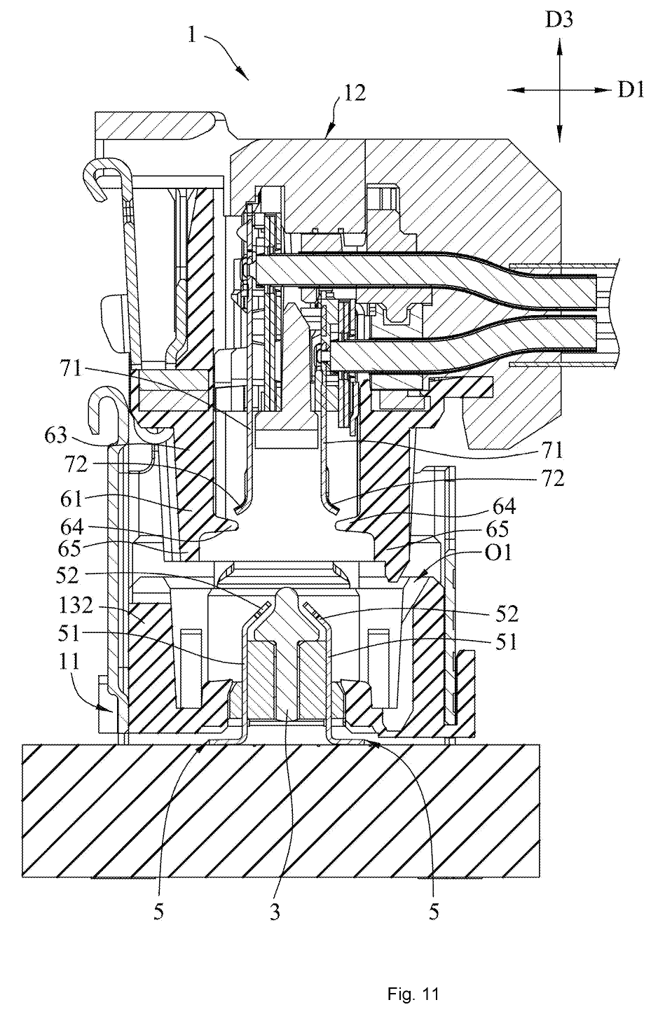

Referring to FIG. 2, FIG. 3 and FIG. 11, a mating manner that the plug connector 12 mates with the receptacle connector 11 to constitute the electrical connection device 1 is shown in FIG. 3 and FIG. 11, the housing peripheral wall 63 of the plug connector 12 is aligned with the insertion opening O1 of the insulative base 132 of the receptacle connector 11, the plug connector 12 is moved into the receptacle connector 11 from up to down along the third direction D3, so that the two contacting portions 72 respectively press against the two contacting portions 52, and are compliantly splayed by the two contacting portions 52, until the housing peripheral wall 63 of the plug connector 12 abuts against the insulative base 132 of the receptacle connector 11, that is, the mating is completed.

A first characteristic of the present embodiment lies in that: when the plug connector 12 and the receptacle connector 11 mate with each other in a case that the plug connector 12 and the receptacle connector 11 are not aligned with each other, the protective base 3 of the receptacle connector 11 may avoid the bottom housing 61 of the plug connector 12 colliding the two contacting portions 52, and the two first protecting walls 64 of the plug connector 12 may avoid a part of the receptacle connector 11 except the two receptacle terminal groups 5 colliding the two plug terminal groups 16.

Moreover, because the two first protecting walls 64 are adjacent to the two long wall portions 631 of the housing peripheral wall 63 respectively, or in other words, the two long wall portions 631 protrude respectively from the two first protecting walls 64 in the third direction D3, so that parts of the two long wall portions 631 which protrude respectively from the two first protecting walls 64 form the two second protecting walls 65 respectively, the two second protecting walls 65 may be regarded as a first protection, and the two first protecting walls 64 may be regarded as a second protection. That is to say, the present embodiment practically has a double protecting characteristic.

Referring to FIG. 9 to FIG. 11, a second characteristic of the present embodiment lies in that: a left end and a right end of the first protecting wall 64 in the left-right direction D2 respectively connect the two short wall portions 632of the housing peripheral wall 63 of the bottom housing 61, so the two first protecting walls 64 are stronger in structure strength, and may provide better protecting effect. In addition, the first wall surface 641 and the second wall surface 642 of each first protecting wall 64 extend away from the housing peripheral wall 63 of direction and toward each other, so that a part of each first protecting wall 64 which connects the respective long wall portion 631 is thicker, and a part of each first protecting wall 64 which forms the respective wall edge 643 is thinner. As such, the part of each first protecting wall 64 which is thicker may have better support, and the part of each first protecting wall 64 which is thinner may have elastic buffering effect when the part of each first protecting wall 64 which is thinner may be collided. Finally, the two wall edges 643 of the two first protecting wall 64 may avoid the two receptacle terminal groups 5 of the receptacle connector 11 being scratched by the two first protecting walls 64 respectively when the plug connector 12 mates with the receptacle connector 11.

Referring to FIG. 2, FIG. 5 and FIG. 6, a third characteristic of the present embodiment lies in that: the two terminal bases 2 and the protective base 3 are assembled together by snapping therebetween, has characteristic which is beneficial to be manufactured. Specifically, the insulative base 132, the two terminal bases 2 and the protective base 3 are not one integral component which is complex in structure but all may be components which are separately formed by insert molding, which has characteristic that difficulty of insert molding is lower.

A fourth characteristic of the present embodiment lies in that: the contacting portion 52 of each receptacle terminal group 5 and the respective oblique surface 321 of the protective base 3 are spaced apart from each other to form a gap, the gap provides displacement space of elastic deformation of the respective contacting portion 52, as such, when each contacting portion 52 is pressed against by the respective plug terminal group 16, each contacting portion 52 may be slightly deformed, and generates an elastic force against the respective plug terminal group 16. That is to say, the design that each contacting portion 52 and the respective oblique surface 321 are spaced apart from each other may ensure that each contacting portion 52 tightly abuts against the respective contacting portion 72.

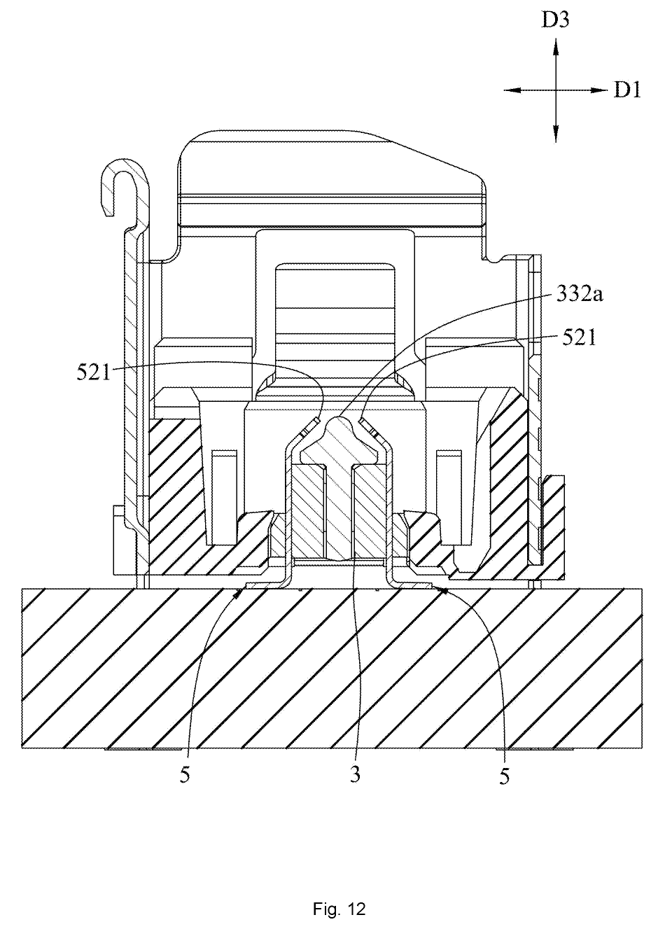

Referring to FIG. 12, a second embodiment of the receptacle connector, the plug connector and the electrical connection device of the present disclosure is similar to the first embodiment, difference lies in that, the flange portion 33 of the protective base 3 extends upwardly from the base portion 32 to be in the same height as the two tips 521 of the two receptacle terminal groups 5, so that the flange portion 33 of the protective base 3 does not protrude from the two receptacle terminal groups 5 in the third direction D3. Or it also may be regarded as that, the two receptacle terminal groups 5 and the curved surface edge 332a of the curved surface 332 of the protective base 3 are in the same height, so the two receptacle terminal groups 5 do not protrude from the protective base 3 in the third direction D3.

In the second embodiment, because the curved surface edge 332a and the two tips 521 are in the same height, when the plug connector 12 (see FIG. 3) hits or collides the two tips 521 by an improper part of the plug connector 12, the improper part of the plug connector 12 also will contact the curved surface edge 332a of the protective base 3. As such, the curved surface edge 332a disperses colliding strength or contacting pressure, and also may lower probability of damage of the two receptacle terminal groups 5.

In conclusion, a technical effect of the receptacle connector, the plug connector and the electrical connection device of the present disclosure lies in that: in the receptacle connector 11, the protective base 3 may avoid the two receptacle terminal groups 5 being damaged, in the plug connector 12, the two first protecting walls 64 and the two second protecting walls 65 may avoid the two plug terminal groups 16 being damaged, so that the electrical connection device 1 is not prone to occurrence of damage of the terminal(s).

However, the above description is only for the embodiments of the present disclosure, and it is not intended to limit the claims of the present disclosure, and the simple equivalent changes and modifications made according to the claims and the specification are still included in the claims of the present disclosure.

What is claimed is:

1. A receptacle connector, comprising:
a metal shell;
an insulative base provided in the metal shell and comprising an insertion opening; and
a receptacle terminal assembly provided in the insulative base and comprising two terminal bases, a protective base which is provided between the two terminal bases, and two receptacle terminal groups which are respectively provided to the two terminal bases, the protective base and the two receptacle terminal groups being spaced apart from each other, each receptacle terminal group extending toward the insertion opening and below a top of the protective base.

2. The receptacle connector of claim 1, wherein
the protective base comprises a base portion which is positioned between the two receptacle terminal groups, and a flange portion which protrudes from the two receptacle terminal groups toward the insertion opening.

3. The receptacle connector of claim 2, wherein
the flange portion comprises a curved surface which curves and protrudes toward the insertion opening.

4. The receptacle connector of claim 3, wherein
the flange portion further comprises two end oblique surfaces which are respectively positioned to two opposite ends of the curved surface.

5. The receptacle connector of claim 4, wherein
the protective base comprises two oblique surfaces which extends toward the insertion opening and toward each other,
each receptacle terminal group comprises a contacting portion which is toward the insertion opening, the contacting portion is parallel to the respective oblique surface of the protective base ,
each oblique surface is spaced apart from the respective contacting portion.

6. The receptacle connector of claim 1, wherein
the two terminal bases comprises a plurality of first engaging portions which are engaged to the protective base so that the two terminal bases are engaged together.

7. The receptacle connector of claim 6, wherein
the protective base is formed with a multiple engaging holes, the plurality of first engaging portions are positioned in the multiple engaging holes respectively.

8. The receptacle connector of claim 7, wherein
the protective base comprises a plurality of legs, the plurality of legs define the multiple engaging holes.

9. The receptacle connector of claim 1, wherein
the protective base is made from an insulative material.

10. A plug connector, comprising:
a plug housing unit, comprising a housing peripheral wall which defines an inserting space, and two first protecting walls which connect the housing peripheral wall, the inserting space comprising an inserting opening, the two first protecting walls being adjacent to the inserting opening and extending toward each other to cooperate with each other and define an insert opening; and
two plug terminal groups, each plug terminal group comprising a tip, each tip being sheltered by the respective first protecting wall so that the tip is not exposed in the insert opening.

11. The plug connector of claim 10, wherein
a part of the housing peripheral wall which is positioned between each first protecting wall and the inserting opening forms each second protecting wall.

12. The plug connector of claim 11, wherein
each first protecting wall extends along a left-right direction and connects the housing peripheral wall, the housing peripheral wall has a pair of long wall portions which extend along the left-right direction and are spaced apart from each other, the two second protecting walls are respectively positioned to the two long wall portions.

13. The plug connector of claim 11, wherein
each first protecting wall comprises a first wall surface which is toward the inserting opening, a second wall surface which is away from the inserting opening, and a wall edge which is connected between the first wall surface and the second wall surface and is toward the other first protecting wall,
each tip is close to the housing peripheral wall relative to the respective wall edge.

14. The plug connector of claim 13, wherein
an angle between each second wall surface and a wall surface of the housing peripheral wall is an obtuse angle and wherein each first wall surface and the respective second wall surface extend away from the housing peripheral wall and extend toward each other.

15. An electrical connection device, comprising:
a receptacle connector, comprising:
a metal shell;
an insulative base provided in the metal shell and comprising an insertion opening; and
a receptacle terminal assembly provided in the insulative base and comprising two terminal bases, a protective base which is provided between the two terminal bases, and two receptacle terminal groups which are respectively provided to the two terminal bases, the protective base and the two receptacle terminal groups being spaced apart from each other, each receptacle terminal group extending toward the insertion opening and below a top of the protective base;
a plug connector, separably mating with the receptacle connector, and comprising:
a plug housing unit, comprising a housing peripheral wall which defines an inserting space, and two first protecting walls which connect the housing peripheral wall, the inserting space comprising an inserting opening, the two first protecting walls being adjacent to the inserting opening and extending toward each other to cooperate with each other and define an insert opening; and
two plug terminal groups, each plug terminal group comprising a tip, each tip being sheltered by the respective first protecting wall so that the tip is not exposed in the insert opening.

16. The electrical connection device of claim 15, wherein
the protective base of the receptacle connector comprises a base portion which is positioned between the two receptacle terminal groups, and a flange portion which protrudes from the two receptacle terminal groups toward the insertion opening.

17. The electrical connection device of claim 15, wherein
the two terminal bases of the receptacle connector comprises a plurality of first engaging portions which are engaged to the protective base so that the two terminal bases are engaged together.

18. The electrical connection device of claim 17, wherein
the protective base of the receptacle connector is formed with a multiple engaging holes, the plurality of first engaging portions are positioned in the multiple engaging holes respectively.

19. The electrical connection device of claim 15, wherein
a part of the housing peripheral wall of the plug connector which is positioned between each first protecting wall and the inserting opening forms a second protecting wall.

20. The electrical connection device of claim 19, wherein
each first protecting wall extends along a left-right direction and connects the housing peripheral wall, the housing peripheral wall has a pair of long wall portions which extend along the left-right direction and are spaced apart from each other, the two second protecting walls are respectively positioned to the two long wall portions.
